(19) United States
(12) Patent Application Publication
(10) Pub. No.: US 2009/0189318 A1
(43) Pub. Date: Jul. 30, 2009

(54) Bottom-up electrospinning devices, and nanofibers prepared by using the same

(76) Inventor: Hak-Yong Kim, Chonrabuk-do (KR)

Correspondence Address: BIRCH STEWART KOLASCH & BIRCH, PO BOX 747, FALLS CHURCH, VA, 22040-0747, US

(21) Appl. No.: 10/585,332

(22) PCT Filed: Jan. 30, 2004
(86) PCT No.: PCT/KR04/00166

§ 371 Date: Jul. 6, 2006

(51) Int. Cl. B29C 47/00; B29C 47/08

(52) U.S. Cl. 264/465; 425/66

(57) ABSTRACT

A conventional electrospinning devices is problematic in that the productivity is low and a droplet, by which a spinning liquid is not formed into fiber but dropped in a drop shape, occurs, to thereby deteriorate the quality of a nonwoven fabric. To solve the above problem, the present invention provides an bottom-up electrospinning devices, comprising: a spinning liquid main tank 1; a metering pump 2; a nozzle block 4; nozzles 5 installed on the nozzle block; a collector 7 for collecting fibers being spun from the nozzle block; and a voltage generator 9 for applying a voltage to the nozzle block 4 and the collector 7, wherein [A] the outlets of nozzles 5 installed on a nozzle block are formed in an upper direction; [B] a collector 7 is located on the top part of the nozzle block; and [C] a spinning liquid discharge device 12 is connected to the uppermost part of the nozzle block 4.

### TECHNICAL FIELD

The present invention relates to a bottom-up electrospinning devices which is capable of mass production of fibers having a nano level thickness (hereinafter, ‘nanofiber’), and a nanofiber produced using the same.

Products such as nonwoven fabrics, membranes, braids, etc. composed of nanofibers are widely used for daily necessaries and in agricultural, apparel and industrial applications, etc. Concretely, they are utilized in a wide variety of fields, including artificial leathers, artificial suede, sanitary pads, clothes, diapers, packaging materials, miscellaneous goods materials, a variety of filter materials, medical materials such as gene transfer elements, military materials such as bullet-proof vests, and the like.

### BACKGROUND ART

A conventional electrospinning devices and a method for producing nanofibers using the same disclosed in U.S. Pat. No. 4,044,404 are described as follows. The conventional electrospinning devices comprises: a spinning liquid main tank for storing a spinning liquid; a metering pump for quantitatively feeding the spinning liquid; a nozzle block with a plurality of nozzles arranged for discharging the spinning liquid; a collector located on the lower end of the nozzles and for collecting spun fibers; and a voltage generator for generating a voltage.

Namely, the conventional electrospinning devices is a bottom-up electrospinning devices in which a collector is located at the lower end of the nozzles.

The conventional method for producing nanofibers using the bottom-up electrospinning devices will be described in more detail. A spinning liquid in the spinning liquid main tank continues to be quantitatively fed into the plurality of nozzles with a high voltage through the metering pump.

Continually, the spinning liquid fed into the nozzles is spun and collected on the collector with a high voltage through the nozzles to form a single fiber web.

Continually, the single fiber web is embossed or needle-punched to prepare a nonwoven fabric.

The aforementioned conventional bottom-up electrospinning devices and the method for producing nanofibers using the same is problematic in that a spinning liquid is continuously fed to nozzles with a high voltage applied thereto to thereby greatly deteriorate the electric force effect.

Meanwhile, a conventional horizontal electrospinning devices with nozzles and a collector arranged in a horizontal direction has a drawback that it is very difficult to arrange a plurality of nozzles for spinning. That is, it is difficult to arrange the nozzles located on the uppermost line, the nozzles located on the lowermost line and the collector at the same spinning distance (tip-to-collector distance) in order to raise a nozzle plate including nozzles and a spinning liquid in a direction horizontal to the collector, thus there is no alternative but to arrange a limited number of nozzles.

Generally, electrospinning is carried out at a very low throughput rate of 10⁻² to 10⁻³ g/min per hole. Thus, for mass production needed in commercialization, a plurality of nozzles should be arranged in a narrow space.

However, in the conventional electrospinning devices, it is impossible to arrange a limited number of nozzles in a predetermined space as explained above, thus making mass production needed for commercialization difficult.

The conventional electrospinning devices has a problem that electrospinning is mostly done at about one hole level and this disables mass production to make commercialization difficult.

Further, the conventional horizontal electrospinning devices has another problem that there occurs a phenomenon (hereinafter, referred to as ‘droplet’) that a polymer liquid aggregate not spun through the nozzles is adhered to a collector plate, thereby deteriorating the quality of the product.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic view of a process of producing a nanofiber web using a bottom-up electrospinning devices in accordance with the present invention;

FIG. 2 is a schematic view of a process for coating nanofibers on a coating material using the bottom-up electrospinning devices in accordance with the present invention;

FIG. 3 is a schematic view of a process for producing a hybrid type nanofiber web using the bottom-up electrospinning devices in accordance with the present invention;

FIG. 4 is a pattern diagram of a nozzle block 4;

FIGS. 5 and 7 are pattern diagrams showing the side of a nozzle 5;

FIGS. 6 and 8 are plane views exemplifying the nozzle 5;

FIG. 9 is an electron micrograph of a nanofiber nonwoven fabric produced in Example 1 of the present invention;

FIG. 10 is an electron micrograph of a nanofiber nonwoven fabric produced in Example 2 of the present invention;

FIG. 11 is an electron micrograph of a nanofiber nonwoven fabric produced in Example 3 of the present invention;

FIG. 12 is an electron micrograph of the nanofiber nonwoven fabric of FIG. 11 after sintering;

FIG. 13 is an electron micrograph of a polyurethane nanofiber nonwoven fabric produced in Example 4 of the present invention;

FIG. 14(a) is a cross sectional view of a spinning liquid dropping device 3 in the present invention; and

FIG. 14(b) is a perspective view of the spinning liquid dropping device 3 in the present invention.

### REFERENCE NUMERALS FOR MAIN PARTS IN THE DRAWINGS

1: spinning liquid main tank 2: metering pump
3: spinning liquid dropping device
3a: filter of spinning liquid dropping device
3b: gas inlet pipe 3c: spinning liquid induction pipe
3d: spinning liquid discharge pipe 4: nozzle block
4b: nozzle circumferential hole 4c: insulator plate
4d: spinning liquid temporary storage plate 4e: nozzle plate
4f: spinning liquid main feed plate 4g: heating device
4h: conductive plate
5: nozzle 6: nanofiber 7: collector (conveyer belt)
8a,8b: collector supporting roller 9: voltage generator
10: nozzle block bilateral reciprocating device
11a: motor for stirrer 11b: nonconductive insulating rod
11c: stirrer 12: spinning liquid discharge device
13: feed pipe 14: web supporting roller 15: web
16: web takeup roller 17: coating material feed roller
θ: nozzle outlet angle L: nozzle length Di: nozzle inner diameter
Do: nozzle outer diameter

### DISCLOSURE OF THE INVENTION

The present invention provides a bottom-up (upward) electrospinning devices which is capable of mass production of nanofiber, acquiring a high productivity per unit time by arrange a plurality of nozzles in a narrow area, and producing a nanofiber of high quality and a nonwoven fabric thereof by preventing a droplet phenomenon. For this purpose, the present invention proposes a bottom-up electrospinning devices in which a nozzle block is located at the lower end of a collector.

To achieve the above objects, there is provided a bottom-up (upward) electrospinning devices in accordance with the present invention, wherein: [A] the outlets of nozzles installed on a nozzle block 4 are formed in an upper direction; [B] a collector is located on the top part of the nozzle block 4; and [C] a spinning liquid discharge device 12 is connected to the uppermost part of the nozzle block.

Hereinafter, the present invention will be described in detail with reference to the accompanying drawings.

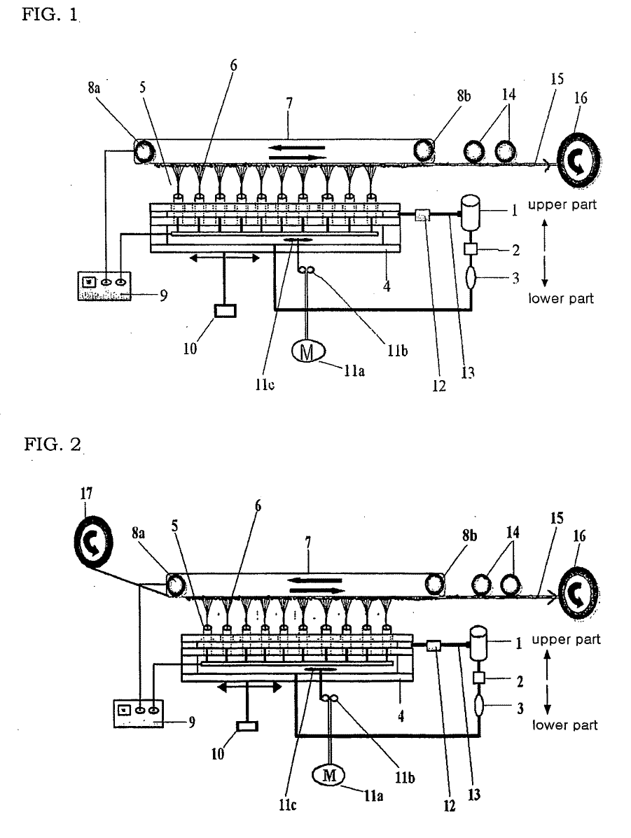

As shown in FIG. 1, a bottom-up electrospinning devices of the present invention includes: a spinning liquid main tank 1 for storing a spinning liquid; a metering pump 2 for quantitatively feeding the spinning liquid; a bottom-up nozzle block 4 with nozzles 5 consisting of a plurality of pins combined in a block shape and for discharging the spinning liquid onto fibers; a collector 7 located above the nozzle block and for collecting single fibers being spun; a voltage generator 9 for generating a high voltage; and a spinning liquid discharge device 12 connected to the uppermost part of the nozzle block.

In the present invention, the outlets of the nozzles 5 installed on the nozzle block 4 are formed in an upper direction, and the collector 7 is located above the nozzle block 4 to spin a spinning liquid in an upper direction.

As shown in FIG. 4, the nozzle block 4 includes: [A] a nozzle plate 4e with nozzles 5 arranged thereon; [B] nozzle circumferential holes 4b surrounding the nozzles 5; [C] a spinning liquid temporary feed plate 4d connected to the nozzle circumferential holes 4b and located right above the nozzle plate 4e; [D] an insulator plate 4c located right above the spinning liquid temporary feed plate 4d; [E] a conductive plate 4h having pins arranged thereon in the same way as the nozzles are and located right below the nozzle plate 4e; [F] a spinning liquid main feed plate 4f including the conductive plate 4h therein; [G] a heating device 4g located right below the spinning liquid main feed plate 4f; and [H] a stirrer 11c installed within the spinning liquid main feed plate 4f.

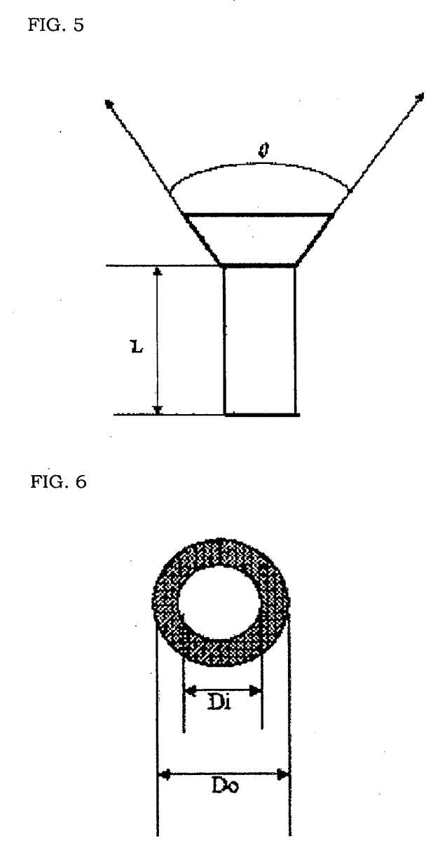

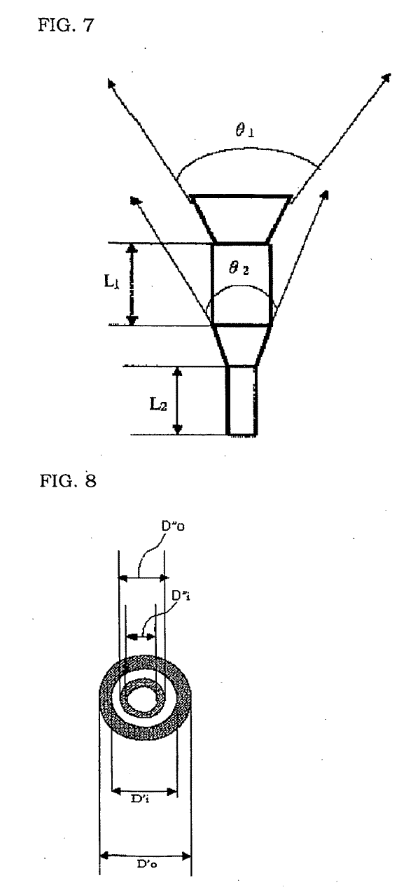

As shown in FIGS. 5 and 7, the outlets of the nozzles 5 are formed in more than one horn whose exit is enlarged. At this time, the angle θ is 90 to 175°, more preferably 95 to 150°, for stably forming spinning liquid drops of the same shape in the outlets of the nozzles 5.

If the angle θ of the nozzle outlets is more than 175°, drops formed in the nozzle region become larger to increase the surface tension. As a result, an even higher voltage is required to form nanofibers. And, as spinning gets started not at the drop center regions but at the periphery portions, the drop center regions are solidified to block the nozzle outlets.

Meanwhile, if the angle θ of the nozzle outlets is less than 90°, the drops formed in the nozzle outlet regions are very small. Thus, if an electric field becomes instantaneously nonuniform or the feeding to the nozzle outlet regions becomes slightly nonuniform, this may lead to the abnormalcy of a drop shape to thereby disable fiber formation and occur a droplet phenomenon.

The present invention does not specifically limit the length of the nozzles L, L1 and L2.

However, it is preferred that the nozzle inner diameter Di is 0.01 to 5 mm and the nozzle outer diameter Do is 0.01 to 5 mm. If the nozzle inner diameter or nozzle outer diameter is less than 0.01 mm, the droplet phenomenon may occur frequently. If more than 5 mm, this may disable fiber formation.

FIGS. 5 and 6 show the side and plane of a nozzle with one enlarged portion (angle) formed thereto. FIGS. 7 and 8 shows the side and plane of a nozzle with two enlarged portions (angle) formed thereto. Namely, θ1 as shown in FIG. 7 is the angle of a first nozzle outlet at which a spinning liquid is spun, and θ2 is the angle of a second nozzle outlet at which the spinning liquid is fed.

A plurality of nozzles 5 in the nozzle block 4 are arranged on the nozzle plate 4e, and nozzle circumferential holes 4b surrounding the nozzles 5 are installed on the outer parts of the nozzles 5.

The nozzle circumferential holes 4b are installed for the purpose of preventing a droplet phenomenon which occurs in the event that an excessive quantity of a spinning liquid formed in the nozzle 5 outlets are not all made into fibers and recovering an overflowing spinning liquid, and play the role of gathering the spinning liquids not made into fibers at the nozzle outlets and feeding them to the spinning liquid temporary feed plate 4d located right above the nozzle plate 4e.

Of course, the nozzle circumferential holes 4b have a larger diameter than the nozzles 5 and preferably formed of an insulating material.

The spinning liquid temporary feed plate 4d is made from an insulating material and plays the role of temporally storing the residual spinning liquid introduced through the nozzle circumferential holes 4b and feeding it to the spinning liquid main feed plate 4f.

An insulator plate 4c is installed right above the spinning liquid temporary feed plate 4d and plays the role of protecting the nozzle top part so that spinning can be smoothly done only in the nozzle regions.

The conductive plate 4h with pins arranged in the same manner as the nozzles are is installed right below the nozzle plate 4e, and the spinning liquid main feed plate 4f including the conductive plate 4h is installed.

Further, the heating device 4g of direct heating type is installed right below the spinning liquid main feed plate 4f.

The conductive plate 4h plays the role of applying a high voltage to the nozzles 5, and the spinning liquid main feed plate 4f plays the role of storing a spinning liquid introduced from the spinning liquid dropping devices 3 to the spinning block 4. At this time, the spinning liquid main feed plate 4f is preferably produced to occupy a minimum space so as to minimize the storage amount of the spinning liquid.

Meanwhile, the spinning liquid dropping device 3 of the present invention is overally designed to have a sealed cylindrical shape as shown in FIGS. 14(a) and 14(b) and plays the role of feeding the spinning liquid in a drop shape continuously introduced from the spinning liquid main tank 1 to the nozzle block 4.

The spinning liquid dropping device 3 has an overally sealed cylindrical shape as shown in FIGS. 14(a) and 14(b). FIG. 14(a) is a cross sectional view of the spinning liquid dropping device and FIG. 14(b) is a perspective view of the spinning liquid dropping device. A spinning liquid induction pipe 3c for inducting a spinning liquid toward the nozzle block and an gas inlet pipe 3b are arranged side by side on the upper end of the spinning liquid dropping device 3. At this time, it is preferred to form the spinning liquid induction pipe 3c slightly longer than the gas inlet pipe 3b.

Gas is introduced from the lower end of the gas inlet pipe, and the portion at which gas is firstly introduced is connected to a filter 3a. A spinning liquid discharge pipe 3d for inducting a dropped spinning liquid to the nozzle block 4 is formed on the lower end of the spinning liquid dropping device 3. The middle part of the spinning liquid dropping device 3 is formed in a hollow shape so that the spinning liquid can be dropped at the tip of the spinning liquid induction pipe 3c.

The spinning liquid introduced to the spinning liquid dropping device 3 flows down along the spinning liquid induction pipe 3c and then dropped at the tip thereof, to thus block the flow of the spinning liquid more than once.

The principle of the dropping of the spinning liquid will be described concretely. If gas is introduced to the upper end of the sealed spinning liquid dropping device 3 along the filter 3a and the gas inlet pipe 3b, the pressure of the spinning liquid induction pipe 3c becomes naturally non-uniform by a gas eddy current or the like. Due to a pressure difference generated at this time, the spinning liquid is dropped.

In the present invention, as the gas to be introduced, can be used air, inert gases such as nitrogen, etc.

The entire nozzle block 4 of the present invention bilaterally reciprocates perpendicular to the traveling direction of nanofibers electrospun by a nozzle block bilateral reciprocating device 10 in order to make the distribution of electrospun nanofibers uniform.

Further, in the nozzle block, more concretely, in the spinning liquid main feed plate 4f, a stirrer 11c stirring the spinning liquid being stored in the nozzle block 4 is installed in order to prevent the spinning liquid from gelling.

The stirrer 11c is connected to a motor 11a by a nonconductive insulating rod 11b.

Once the stirrer 11c is installed in the nozzle block 4, it is possible to prevent the gelation of the spinning liquid in the nozzle block 4 effectively when electrospinning a liquid containing an inorganic metal or when electrospinning the spinning liquid dissolved with a mixed solvent for a long time.

Additionally, a spinning liquid discharge device 12 is connected to the uppermost part of the nozzle block 4 for forcedly feeding the spinning liquid excessively fed into the nozzle block to the spinning liquid main tank 1.

The spinning liquid discharge device 12 forcedly feeds the spinning liquid excessively fed into the nozzle block to the spinning liquid main tank 1 by a suction air or the like.

Further, a heating device (not shown) of direct heating type or indirect heating type is installed (attached) to the collector 7 of the present invention, and the collector 7 is fixed or continuously rotates.

The nozzles 5 located on the nozzle block 4 are arranged on a diagonal line or a straight line.

Next, a method for producing a nonwoven fabric using the bottom-up electrospinning devices of the present invention will be described.

Firstly, thermoplastic resin or thermosetting resin spinning liquid is metered by a metering pump 2 and quantitatively fed to a spinning liquid dropping device 3. At this time, the thermoplastic resin or thermosetting resin used for preparing the spinning liquid includes polyester resin, acryl resin, phenol resin, epoxy rein, nylon resin, poly(glycolide/L-lactide) copolymer, poly(L-lactide) resin, polyvinyl alcohol resin, polyvinyl chloride resin, etc. As the spinning liquid, either the resin melted solution or any other solution can be used.

The spinning liquid fed into the spinning liquid dropping device 3 is fed to the spinning liquid main feed plate 4f of the nozzle block 4 of the invention, to which a high voltage is applied and a stirrer 11c is installed, in a discontinuous manner, i.e., in such a manner to block the flow of the spinning liquid more than once, while passing through the spinning liquid dropping device 3. The spinning liquid dropping device 3 plays the role of blocking the flow of the spinning liquid so that electricity cannot flow in the spinning liquid main tank 1.

Continuously, the nozzle block 4 upwardly discharges the spinning liquid through bottom-up nozzles to the collector 7 at the top part where a high voltage is applied, thereby preparing a nonwoven fabric web.

The spinning liquid fed to the spinning liquid main feed plate 4f is discharged to the collector 7 in the top part through the nozzles 5 to form fibers. The excess spinning liquid not made into fibers at the nozzles 5 is gathered at the nozzle circumferential holes 4b, passes through the spinning liquid temporary feed plate 4d and moves again to the spinning liquid main feed plate 4f.

Further, the spinning liquid excessively fed to the uppermost part of the nozzle block is forcedly fed to the spinning liquid main tank 1 by the spinning liquid discharge device 12.

At this time, to promote fiber formation by an electric force, a voltage of more than 1 kV, more preferably, more than 20 kV, generated from a voltage generator 6 is applied to the conductive plate 4h and collector 7 installed at the lower end of the nozzle block 4. It is more advantageous to use an endless belt as the collector 7 in view of productivity. It is preferable that the collector 7 reciprocates to the left and the right within a predetermined distance in order to make uniform the density of the nonwoven fabric.

The nonwoven fabric formed on the collector 7, passes through a web supporting roller 14 and is wound around a takeup roller 16, thereby finishing a nonwoven fabric producing process.

By the use of the above-described bottom-up nozzle block 4, the producing devices of the present invention is capable of improving the nonwoven fabric quality by effectively preventing a droplet phenomenon, and mass-producing nanofibers and nonwoven fabrics since the fiber formation effect becomes higher with an increase of electric force. Moreover, the producing method of the present invention can freely change and adjust the width and thickness of a nonwoven fabric by arranging nozzles consisting of a plurality of pins in a block shape.

A nanofiber nonwoven fabric produced by the devices of the present invention is used for various purpose, including artificial leather, a sanitary pad, a filter, medical materials such as an artificial vessel, a cold protection vest, a wiper for a semiconductor, a nonwoven fabric for a battery and the like.

The present invention comprises a method for coating nanofibers on a nonwoven fabric, a woven fabric, a knitted fabric, a film and membrane film (hereinafter, ‘coating materials’) by using the bottom-up electrospinning devices.

FIG. 2 is a schematic view of a process for coating nanofibers on a coating material using the bottom-up electrospinning devices in accordance with the present invention.

Concretely, while a coating material is continuously fed onto a collector 7 moving from a coating material feed roller 17, nanofibers are electrospun by the bottom-up electrospinning devices of the present invention on the coating material located on the collector 7, and then the coating material coated with nanofibers is wound by a takeup roller 16.

At this time, it is possible to coat nanofibers in a multilayer by electrospinning more than two kinds of spinning liquids on the coating material, respectively, by respective bottom-up electrospinning devices.

The coating thickness is properly adjustable according to a purpose.

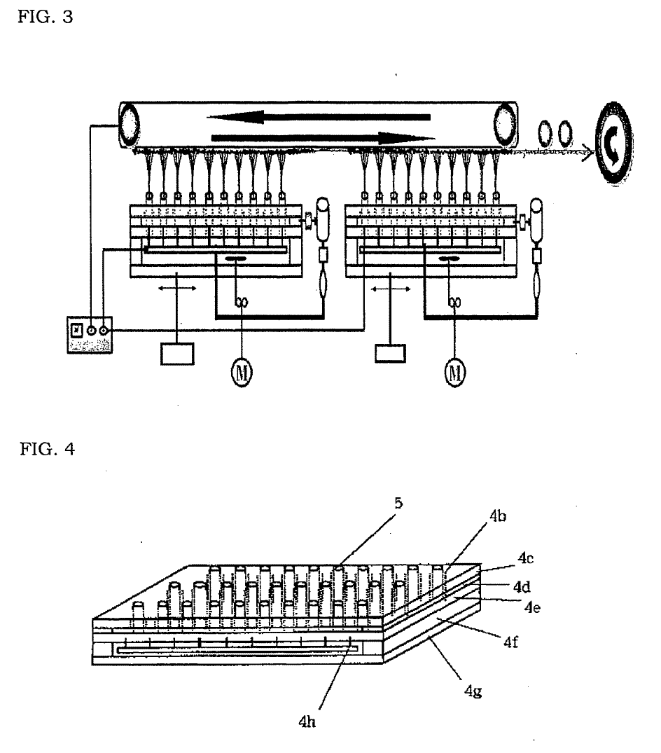

Further, as shown in FIG. 3, the present invention comprises a method for producing a hybrid type nanofiber web by consecutively arranging more than two kinds of bottom-up electrospinning devices side by side and then electrospinning more than two kinds of spinning liquids by respective bottom-up electrospinning devices and a method for manufacturing a hybrid nanofiber web by stacking more than two kinds of nanofiber webs electrospun respectively by the bottom-up electrospinning devices.

FIG. 3 is a schematic view of a process for producing a hybrid type nanofiber web using two bottom-up electrospinning devices arranged side by side, in which reference numerals for main parts of the drawings are omitted.

### ADVANTAGEOUS EFFECT

The present invention enables an infinite nozzle arrangement by arranging a plurality of nozzles on a flat nozzle block plate upon electrospinning of nanofibers, and is capable of enhancing productivity per unit time with the improvement of fiber forming property.

As a result, the present invention is able to commercially produce a nanofiber web. Additionally, the present invention is able to effectively prevent a droplet phenomenon and mass-produce nanofibers of high quality.

### BEST MODE FOR CARRYING OUT THE INVENTION

Hereinafter, the present invention will now be described more concretely through the following examples.

However, the present invention is not limited thereto.

### Example 1

Chips of nylon 6 having a relative viscosity of 3.2 (determined in a 96% sulfuric acid solution) were dissolved in formic acid to prepare a 25% spinning liquid. The spinning liquid had a viscosity of 1200 centipoises (cPs) measured by using Rheometer-DV, III, Brookfield Co., USA, an electric conductivity of 350 mS/m measured by a conductivity meter, CM-40G, TOA electronics Co., Japan, and a surface tension of 58 mN/m measured by a tension meter (K10St, Kruss Co., Germany).

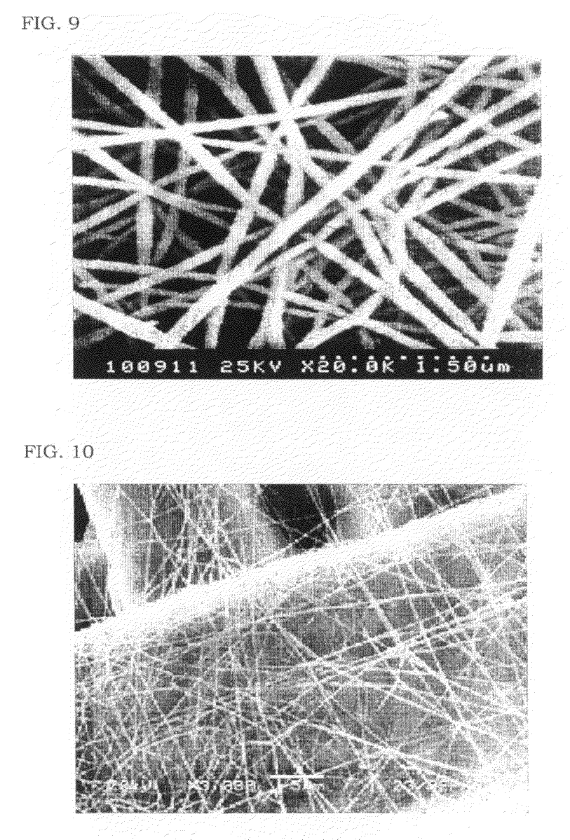

The spinning liquid was stored in a spinning liquid main tank 1, quantitatively metered by a metering pump 2, and then fed to a spinning liquid dropping device 3 to discontinuously change the flow of the spinning liquid. Continually, the spinning liquid was fed to a nozzle block 4 of a bottom-up electrospinning devices as shown in FIG. 1 with a 35 kV voltage applied thereto, spun bottom-up onto fibers through nozzles and collected on a collector 7 located on the top part to produce a nonwoven fabric web having a 60 cm width and 3.0 g/m² weight. At this time, in order to perform electrospinning, the nozzles 5 arranged on the nozzle block 4 were diagonally arranged, the number of nozzles was 3,000, the spinning distance was 15 cm, the throughput per nozzle was 1.2 mg/min, the reciprocating motion of the nozzle block 4 was performed at 2 m/min, an electric heater was installed on the collector 7, and the surface temperature of the collector was 35° C. The spinning liquid flowing over the uppermost part of the nozzle block 4 during the spinning was forcedly carried to the spinning liquid main tank 1 by the use of a spinning liquid discharge device 12 using a suction air. The production velocity of the web was 2 m/min. As the nozzles, used were nozzles having a nozzle outlet angle θ of 120° and a nozzle inner diameter Di of 0.9 mm. As a voltage generator, Model CH 50 of Simco Company was used. The result of photographing the produced nanofiber nonwoven fabric of nylon 6 by an electron microscope is as shown in FIG. 9. The diameter of nanofiber was 200 nm and there occurs no droplet phenomenon at all.

### Example 2

Chips of nylon 6 having a relative viscosity of 3.2 (determined in a 96% sulfuric acid solution) were dissolved in formic acid to prepare a 20% spinning liquid. The spinning liquid had a viscosity of 1050 centipoises (cPs) measured by using Rheometer-DV, III, Brookfield Co., USA, an electric conductivity of 350 mS/m measured by a conductivity meter, CM-40G, TOA electronics Co., Japan, and a surface tension of 51 mN/m measured by a tension meter (K10St, Kruss Co., Germany).

The spinning liquid was stored in a main tank 1, quantitatively metered by a metering pump 2, and then fed to a spinning liquid dropping device 3 to discontinuously change the flow of the spinning liquid. Continually, the spinning liquid was fed to a nozzle block 4 of a bottom-up electrospinning devices as shown in FIG. 1 with a 35 kV voltage applied thereto, spun bottom-up onto fibers through nozzles and electrospun on a collector 7 located on the top part. Meanwhile, a polypropylene nonwoven fabric having a 60 cm width and a 157 g/m² weight was continuously fed onto the collector 7 so that an electrospun nanofiber was coated on the polypropylene nonwoven fabric. At this time, spinning plates of two nozzle blocks each consisting of 3,000 nozzles were consecutively located side by side to perform coating using the total 6,000 nozzles. The traveling speed of the polypropylene nonwoven fabric was 40 m/min. The throughput per nozzle was 1.0 mg/min. The reciprocating motion of the nozzle block was performed at 4 m/min. An electric heater was installed on the collector 7 and the temperature of the collector was set to 35° C. The spinning liquid flowing over the uppermost part of the nozzle block during the spinning was forcedly carried to the spinning liquid main tank 1 by the use of a spinning liquid discharge device 12 using a suction air. The production velocity of the web was 2 m/min. As the nozzles, used were nozzles having a nozzle outlet angle θ of 120° and a nozzle inner diameter Di of 0.9 mm. As a voltage generator, Model CH 50 of Simco Company was used. The result of photographing the produced nanofiber of nylon 6 by coated on the polypropylene nonwoven fabric by an electron microscope is as shown in FIG. 10. The diameter of nanofiber was 156 nm and there occurs no droplet phenomenon at all.

### Example 3

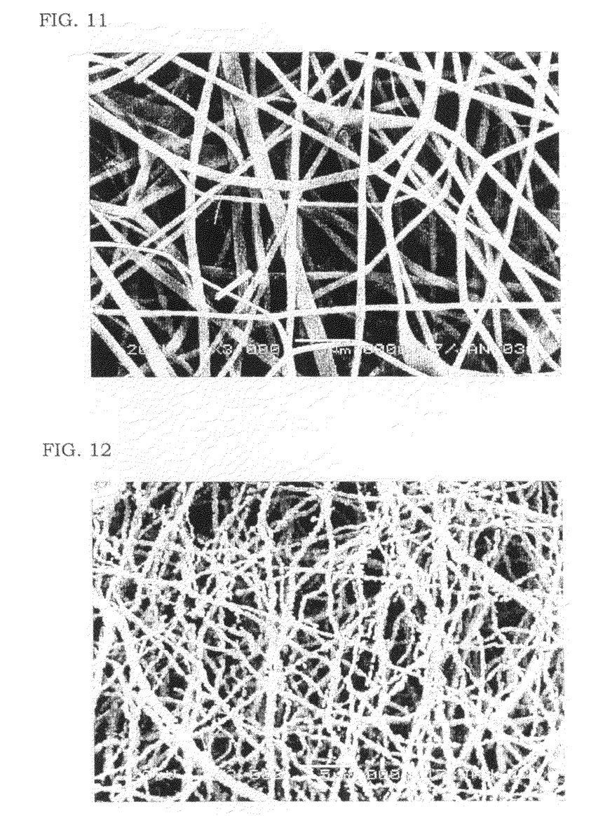

A niobium oxide (NbO2 of 50 weight parts in a solution state) sol solution was prepared from niobium ethoxide by a general sol-gel process. That is, 1,000 g of niobium was dissolved in 1000 g of ethanol and 3 g of acetic acid was added thereto. Then, the mixture was stirred at 40° C. with approximately 100 rpm. After two hours, a sol solution in dim yellow was obtained. Acetic acid functions to prevent precipitation in the preparation of sol and acts as a catalyst for hydrolysis and condensation. 2,500 g of a solution made by dissolving in acetone 14 weight parts of polyvinyl acetate was mixed with 2,000 g of a niobium oxide sol solution. The mixed solution was stirred for 5 hours at 35° C. with 60 rpm. By using this solution, electrospinning was carried out by a bottom-up electrospinning devices. The spinning liquid was stored in a main tank 1, quantitatively metered by a metering pump 2, and then fed to a spinning liquid dropping device 3 to discontinuously change the flow of the spinning liquid. Continually, the spinning liquid was fed to a nozzle block 4 of a bottom-up electrospinning devices as shown in FIG. 1 with a 30 kV voltage applied thereto, spun bottom-up onto fibers through nozzles 5 and collected on a collector 7 located on the top part to produce a nonwoven fabric web having a 60 cm width and 4.0 g/m² weight. At this time, the nozzles 5 arranged on the nozzle block 4 were diagonally arranged, the number of nozzles was 4,000 holes, and the throughput per one nozzle hole was 1.6 mg/min. For preventing gelation, the temperature of the nozzle block was 40° C., a stirrer was installed on the nozzle block to revolve the solution with 30 rpm. To ensure the safety of a stirring rotating motor, a rod made of an insulating material of which the middle part is formed of Teflon was connected to cut off an electric flow. The reciprocating motion of the nozzle block 4 was performed at 2 m/min, an electric heater was installed on the collector 7, and the surface temperature of the collector was 40° C. to carry out electrospinning. The spinning liquid flowing over the uppermost part of the nozzle block 4 during the spinning was forcedly carried to the spinning liquid main tank 1 by the use of a spinning liquid discharge device 12 using a suction air. The production velocity of the web was 1.6 m/min. As the nozzles, used were nozzles having a nozzle outlet angle θ of 120° and a nozzle inner diameter Di of 1.0 mm. As a voltage generator, Model CH 50 of Simco Company was used. The result of photographing the produced nanofiber nonwoven fabric of niobium oxide/poly(vinyl acetate) by an electron microscope is as shown in FIG. 11. The diameter of nanofiber was 250 nm and there occurs no droplet phenomenon at all. Further, as a result of performing sintering for three hours at 1000° C. to produce a pure niobium oxide nanofiber, an inorganic nanofiber as shown in FIG. 12 was produced. As a result of X-ray inspection to inspect a crystal structure, it can be known that the fiber was a pure niobium oxide.

### Example 4

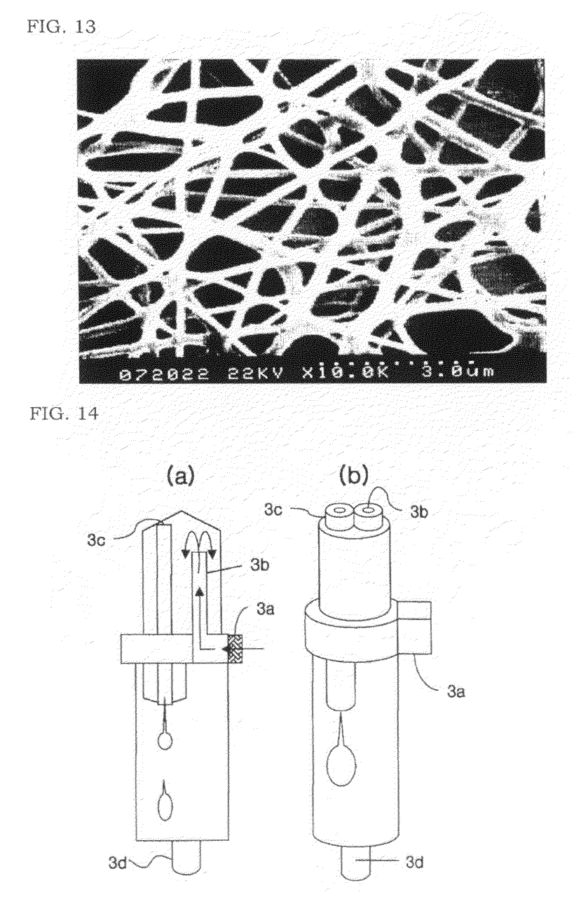

A nanofiber was electrospun by a bottom-up electrospinning devices by using two spinning liquids (spinning liquid A and spinning liquid B). Concretely, as the spinning liquid A, used was a spinning liquid of nylon 6 as shown in Example 1, and, as the spinning liquid B, used was a spinning liquid made by dissolving 10% by weight of polyurethane resin (Pellethane 2103-80AE of Dow Chemical) having an average molecular weight of 80,000 in N, N-dimethylformamide/tetrahydrofuran. The spinning liquid B had a viscosity of 700 centipoises (cPs) measured by using Rheometer-DV III of Brookfield Co., USA, an electric conductivity of 0.15 mS/m measured by a conductivity meter, CM-40G, TOA electronics Co., Japan, and a surface tension of 38 mN/m measured by a tension meter (K10St, Kruss Co., Germany). The spinning liquid A was electrospun by one of two bottom-up electrospinning devices as shown in FIG. 3 in the same process and condition as shown in Example 1. At the same time, the spinning liquid B was electrospun by the other bottom-up electrospinning devices as shown below. The spinning liquid was stored in a main tank 1, quantitatively metered by a metering pump 2, and then fed to a spinning liquid dropping device 3 to discontinuously change the flow the spinning liquid. Continually, the spinning liquid was fed to a nozzle block 4 of a bottom-up electrospinning devices as shown in FIG. 1 with a 35 kV voltage applied thereto, and spun bottom-up onto fibers through nozzles. At this time, in order to perform electrospinning, the nozzles 5 arranged on the nozzle block were diagonally arranged, the number of nozzles was 3,000 holes, the spinning distance was 15 cm, the throughput per one nozzle hole was 1.6 mg/min, the reciprocating motion of the nozzle block was performed at 2 m/min, an electric heater was installed on the collector 7, and the surface temperature of the collector was 85° C. The spinning liquid flowing over the uppermost part of the nozzle block 4 during the spinning was forcedly carried to the spinning liquid main tank 1 by the use of a spinning liquid discharge device 12 using a suction air. As the nozzles, used were nozzles having a nozzle outlet angle θ of 120° and a nozzle inner diameter Di of 0.8 mm. As a voltage generator, Model CH 50 of Simco Company was used. The result of photographing the produced nanofiber nonwoven fabric of nylon 6 by an electron microscope is as shown in FIG. 13. The diameter of nanofiber was 320 nm and there occurs no droplet phenomenon at all.

The produced nylon nanofiber web and the polyurethane nanofiber web were mixed at a traveling speed of 2 m/min to produce a hybrid nanofiber web. As a result of measuring the mechanical physical properties of the nanofiber web of a nylon 6-polyurethane hybrid, the tensile strength was 9 MPa, the elongation was 150% and the elastic modulus was 35 MPa.

What is claimed is:

1. A bottom-up electrospinning devices, comprising: a spinning liquid main tank 1; a metering pump 2; a nozzle block 4; nozzles 5 installed on the nozzle block; a collector 7 for collecting fibers being spun from the nozzle block; and a voltage generator 9 for applying a voltage to the nozzle block 4 and the collector 7,
wherein: [A] the outlets of nozzles 5 installed on a nozzle block 4 are formed in an upper direction; [B] a collector 7 is located on the top part of the nozzle block 4; and [C] a spinning liquid discharge device 12 is connected to the uppermost part of the nozzle block 4.

2. The devices of claim 1, wherein a spinning liquid dropping device 3 is installed between the spinning liquid main tank 1 and the nozzle block 4.

3. The devices of claim 1, wherein the nozzle block 4 is bilaterally reciprocated as a whole.

4. The devices of claim 1, wherein a heating device is installed in the collector 7.

5. The devices of claim 1, wherein a stirrer 11c is installed in the nozzle block 4.

6. The devices of claim 1, wherein a spinning liquid discharge device 12 forcedly feeds an excessively fed spinning liquid to the spinning liquid main tank 1 by a suction air.

7. The devices of claim 1, wherein the collector 7 is fixed or continuously rotates.

8. The devices of claim 1, wherein the nozzles 5 located on the nozzle block 4 are arranged on a diagonal line or a straight line.

9. The devices of claim 1, wherein the outlets of the nozzles 5 are formed in more than one horn having an angle θ of 90 to 175°.

10. The devices of claim 1, wherein the nozzle block 4 comprises: [A] a nozzle plate 4e with nozzles 5 arranged thereon; [B] nozzle circumferential holes 4b surrounding the nozzles 5; [C] a spinning liquid temporary feed plate 4d connected to the nozzle circumferential holes 4b and located right above the nozzle plate 4e; [D] an insulator plate 4c located right above the spinning liquid temporary feed plate 4d; [E] a conductive plate 4h having pins arranged thereon in the same way as the nozzles are and located right below the nozzle plate 4e; [F] a spinning liquid main feed plate 4f including the conductive plate 4h therein; [G] a heating device 4g located right below the spinning liquid main feed plate 4f; and [H] a stirrer 11c installed within the spinning liquid main feed plate 4f.

11. Nanofibers produced by the bottom-up electrospinning devices of claim 1.

12. A method for coating nanofibers, wherein a nanofiber is continuously or discontinuously coated on a coating material by the bottom-up electrospinning devices of claim 1.

13. The method of claim 12, wherein the coating material includes a nonwoven fabric, a woven fabric, a knitted fabric, a film or a membrane film.

14. The method of claim 12, wherein nanofibers are coated in a multilayer by electrospinning more than two kinds of spinning liquids on the coating material, respectively, by respective bottom-up electrospinning devices.

15. A method for producing a hybrid type nanofiber web by consecutively arranging more than two bottom-up electrospinning devices of claim 1 and then electrospinning more than two kinds of spinning liquids sequentially on the collector 7 by the respective electrospinning devices.

16. A method for producing a hybrid type nanofiber web by stacking more than two kinds of nanofiber webs electrospun respectively by the bottom-up electrospinning devices of claim 1.
